(19) United States
(12) Patent Application Publication
(10) Pub. No.: US 2014/0310037 A1
(43) Pub. Date: Oct. 16, 2014

(54) Skills, Expertise, Abilities and Interests Tagging in a Software Environment

(71) Applicant: Cisco Technology, Inc., San Jose, CA (US)

(72) Inventors: Keith Griffin, Galway (IE); Dart Lindsley, Santa Cruz, CA (US); Benjamin Lerch, El Cerrito, CA (US)

(21) Appl. No.: 13/863,618

(22) Filed: Apr. 16, 2013

(51) Int. Cl. G06Q 10/06

(52) U.S. Cl. CPC G06Q 10/0631
USPC 705/7.12

(57) ABSTRACT

Techniques are provided to perform skills, expertise, abilities and interests tagging in in a software (e.g., social networking) environment. Interactions of a user are monitored in a software environment in which information about users is collected based upon user actions. Textual information about or derived from an interaction of the user is obtained. A skill noun is determined from the textual information obtained for the interaction. The determined skill noun and a skill verb are combined to form a user skill tag. A profile of the user is updated with the user skill tag.

### TECHNICAL FIELD

The present disclosure relates to workforce identification and management, and in particular, workforce identification and management though interactions in a software environment.

### BACKGROUND

In order to efficiently manage a workforce, organizations should have an accurate understanding of the skills and abilities of their employees. Accurate data regarding employees' skills and abilities allow organizations to efficiently determine mentoring opportunities, organize comprehensive teams to tackle novel problems, and utilize current employees to address issues without having to seek additional employees or outside help. Expert-finding is also critical as an organization enters new fields or expands product offerings. Accurately understanding the skills and expertise of a workforce can be particularly daunting in innovative companies where the fields of expertise are brand new, and constantly changing.

Current social or profile based expertise systems rely on user or administrator entered expertise tags. If users do not enter expertise information, the system will not accurately capture the current expertise available in a workforce. Alternatively, social tagging (i.e. allowing other users to indicate the expertise of users) can result in incorrect skills being associated with employees.

### BRIEF DESCRIPTION OF THE DRAWINGS

FIG. 1 is flowchart illustrating a method of skills, expertise, abilities and interests tagging in a social networking environment.

FIG. 2 illustrates a process flow for skills, expertise, abilities and interests tagging in an enterprise social network.

FIG. 3 illustrates a skills graph configured to determine skill verbs to be combined with skill nouns to form user skill tags.

FIG. 4 is an example system configured to implement skills, expertise, abilities and interests tagging in an enterprise social network.

FIG. 5 is an example block diagram of a device configured to perform skills, expertise, abilities and interests tagging in an enterprise social network.

FIG. 6 is an example block diagram of a network environment configured to track social network interactions for expertise tag generation and updating.

### DESCRIPTION OF EXAMPLE EMBODIMENTS

### Overview

Techniques are provided to perform skills, expertise, abilities and interests tagging in in a software (e.g., social networking) environment. Interactions of a user are monitored in a software environment in which information about users is collected based upon user actions. Textual information about or derived from an interaction of the user is obtained. A skill noun is determined from the textual information obtained for the interaction. The determined skill noun and a skill verb are combined to form a user skill tag. A profile of the user is updated with the user skill tag.

### Example Embodiments

A method and autonomic system are presented herein to generate and manage expertise tags based on user participation in a social software network system. The system includes role based disambiguation using verbs (in ontology) and crowd-based ontology management.

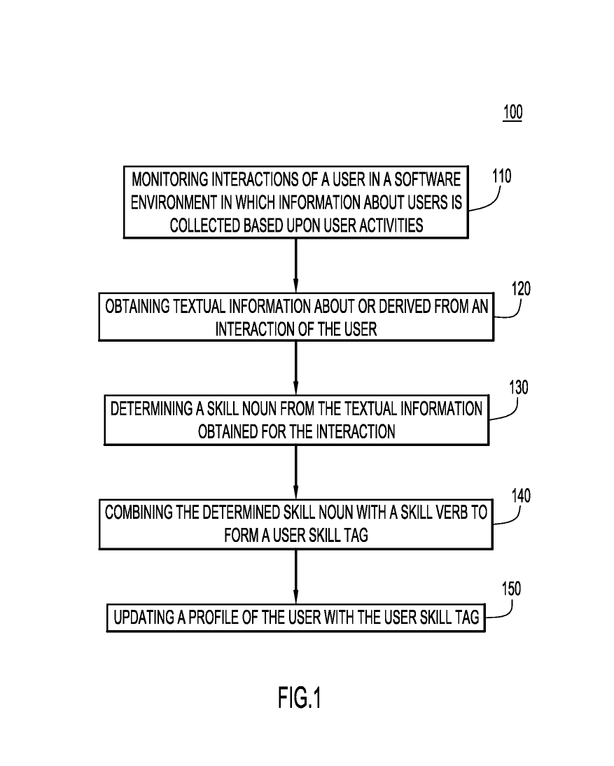

Reference is first made to FIG. 1. Depicted in FIG. 1 is a flowchart illustrating a process by which a user profile can be updated and maintained according to the actions the user associated with the profile performs in a software (e.g., social networking) environment. Specifically, the user skill tags associated with the user will be updated. As used herein, a “user skill tag” can refer to an indication of skills, abilities, expertise, knowledge, interests and other attributes of the user. A user skill tag comprises a “skill noun” indicating the subject area of the specific skill tag, and a skill verb indicating the user's skill, ability, knowledge, interest or other attribute relative to the subject are indicated by the skill noun.

A user skill tag may refer to the combination of the skill noun and the skill verb, resulting in a single tag combining the skill noun and the skill verb. Such a single user skill tag may be associated with the user as a single data item contained within the user's profile. More generally, a user skill tag is a relationship between a skill noun and a skill verb, even if the combination of the skill noun and the skill verb is not stored as a single data item. For example, a user profile may include a list of skill nouns associated with the user, and a list of skill verbs associated with the user. The user skill tag may be an indication of a link between an entry in the skill noun list an entry in the skill verb list. If the lists are stored in database tables, the formation of a user skill tag may include assigning a “key” or other reference linking a row in the user noun table to a row in the user skill table.

The process begins in step 110 in which the interactions of the user are monitored in a software environment. The software environment collects information about users based upon user activities. The software environment may be an enterprise social networking environment or a system in which users have a user profile. A user can include information about himself/herself in his/her user profile, such as areas of interest, areas of expertise, past and current assignments and projects, professional roles and responsibilities, and professional goals. The software environment may also allow users to provide personal information, for example, a user's personal interests and goals.

Users within the software environment are able to interact with other users. For example, the software environment may allow user to communicate by posting informational items to other users' profiles, communicating through electronic mail, communicating through text (e.g., Instant Messaging), audio and video chats, and communicating in online collaborative sessions. All of these interactions may be monitored, i.e. tracked, in the software environment.

In step 120, textual information about or derived from the interactions of the user is obtained. The textual information may be derived from the content of an informational item posted to the user's profile, the content of an informational item posted by the user on someone else's profile, or the content of an e-mail or text based chat sent through the software environment. Similarly, the textual information may be derived from the subject or title of an online collaborative session, or by using voice recognition to determine the content of an audio or video chat session. In general, the textual information may be obtained by any of a variety of techniques now known or hereinafter developed, including voice recognition (audio-to-text), screen-capturing and text recognition, Natural Language Processing (NLP), Entity Extraction, word spotting, and other techniques. These techniques may be applied to Rich Site Summary (RSS) feeds, activity streams, message board posts, blogs, instant messages, wiki entries and other forms of textual and social content.

In step 130, a skill noun is determined from the textual information obtained from the interaction. For example, if the user posts an informational item, such as an article, the contents of the article may be used to derive textual information. The contents of the textual information may be examined to determine the subject of the article, which may be used as a skill noun. Similarly, textual information may be derived from the subject of an online collaborative session or meeting. If the subject of the meeting is a particular product or service provided by an organization, that product or service may be determined to be a skill noun.

In step 140, the skill noun is combined with a skill verb to form a user skill tag. The skill verb may be determined from contextual information known about the user. For example, consider a salesperson that makes a post about a particular product, such as a network router. After determining “network router” as a skill noun, the contextual information that the user is a salesperson may be used to combine “network router” with a skill verb such as “sells” to generate the skill tag “sells network routers.” On the other hand, if the user is an electrical engineer, this contextual information may be used to combine the skill verb “designs” with the determined skill noun “network router” to generate the user skill tag “designs network routers.”

Combining the determined skill noun with the skill verb may be accomplished by referencing an ontology. In information science, an ontology is a way of formally representing the relationships between pairs of concepts. For example, an ontology may show that a salesperson may be related to a network router through the verb “sells.” On the other hand, the ontology may show the that an electrical engineer is related to a network router through the verb “designs” as an electrical engineer is responsible for the design of network routers. Accordingly, once the skill noun is determined, the skill verb may be determined by finding the relationship between the user's contextual information, such as their job, and the skill using the relationships defined by the ontology.

The use of the ontology to determine a skill noun is not limited to the user's role or job. For example, the user's other skills, expertise, abilities, and interests may be used to determine skill verbs to combine with the skill noun. For example, even if the user is a sales person, if their profile indicates the ability to repair network devices, the skill verb “repair” may be combined with the skill noun “network router” for the skill tag “repairs network routers.” If an ontology is used to form the user skill tag, the ontology may indicate the relationship between a network router and network devices (i.e., a network router is a sub-category of network device), and the ontology would also show that the user is related to network devices through the ability to repair network devices. Accordingly, it may be determined through these relationships that the user would have the ability to repair network routers. Therefore, the skill verb “repair” may be combined with the skill noun “network router” to form the user skill tag “repairs network routers.”

Finally, in step 150, the user profile is updated with the user skill tag. Accordingly, if the user profile is searched, it may be determined that the user has the skill, ability, interest, and/or knowledge indicated by the user skill tag.

By combining the skill verb with the skill noun, the process described in FIG. 1 provides role-based disambiguation of user skills, expertise, knowledge and interests. For example, if no skill verbs were added to the skill noun “network router” and “network router” was added to a user's profile, it is ambiguous as to which skill the user has related to network routers. For example, the user may sell, repair, design, install, or have any number of skills related to network routers. Accordingly, if a user's profile simply states the skill noun, it will be ambiguous as to which skill, expertise, knowledge or interest the user actually possesses. By combining the skill verb with the skill noun to form the user skill tag, ambiguity regarding the user's skills, expertise, knowledge and interests can be removed.

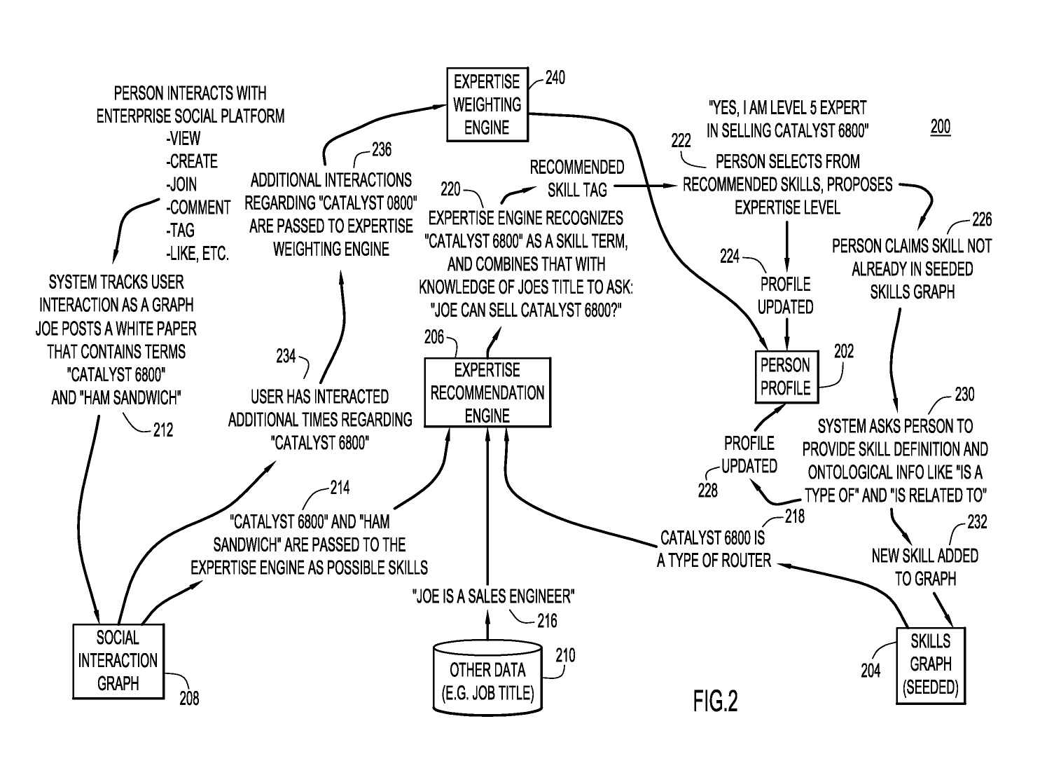

With reference now to FIG. 2, depicted therein is a detailed illustration of the actions and systems of an enterprise social network 200 in which user profiles may be updated with role-based disambiguous user skills employing the techniques of FIG. 1. A user profile shown at reference numeral 202 serves as a repository of information for a user in the enterprise social network 200, and includes the user's skills, expertise, abilities and interests. If, for example, the enterprise social network 200 is hosted by a specific organization, the organization can use information derived from user interactions in the enterprise social network 200 to determine the skills, expertise, abilities and interests of their workforce. Having an accurate understanding of a workforce allows an organization to more efficiently staff projects or tasks of the organization, as well as mentor and support its employees. In order to ensure updated and accurate user profiles 200, the enterprise social network 200 is configured provide an autonomic system to generate and manage user skill tags. Specifically, enterprise social network 200 is configured to automatically update the user profiles 202 without relying on users to initiate or manually determine the contents of updates.

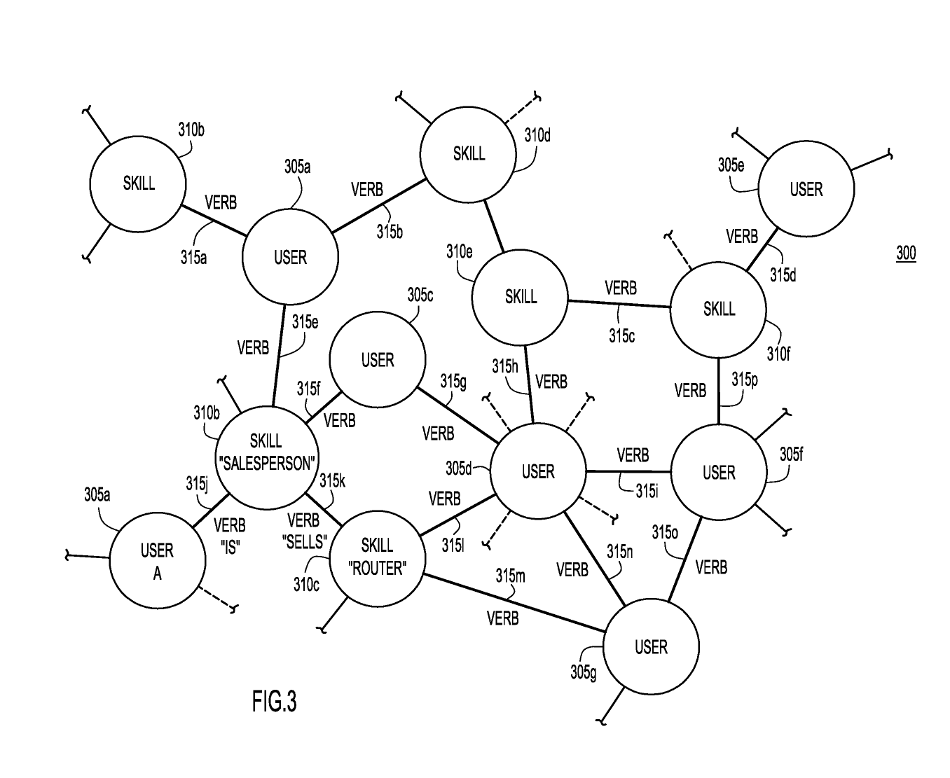

Included in enterprise social network 200 is skills graph 204. The skills graph 204 is seeded with the ontology to be used to determine the relationships between skill nouns and skill verbs, as well as an initial vocabulary of skill nouns and skill verbs. An example of a skills graph is described hereinafter in connection with FIG. 3. The initial seeding of skills graph 204 may include both controlled and uncontrolled skills vocabularies. A controlled skills vocabulary is one which cannot be changed, at least without administrator access. On the other hand, uncontrolled skills vocabularies are crowd sourced and potentially editable by anyone. By allowing users to edit at least some portions of the vocabulary of skills graph 204, skills graph 204 can take advantage of crowd sourcing, ensuring an updated vocabulary without requiring extensive administrator interaction. At the same time, by maintaining some portions of the vocabulary as controlled, an organization can ensure baseline levels of control and security over the skills vocabulary present in skills graph 204.

Also included in enterprise social network 200 is expertise recommendation engine 206 and social interaction graph 208. Social interaction graph 208 maintains information regarding the interactions of users within enterprise social network 200. For example, the subject of user interactions may be stored in social interaction graph 208 along with a representation of the number or frequency of interactions related to the subject. Expertise recommendation engine 206 is configured to determine skill nouns from social interaction graph 208, and then combine the skill nouns with skill verbs determined from skills graph 204.

Also included in enterprise social network 200 is database 210 that can be used to supplement the information in user profiles 202, skills graph 204, and social interaction graph 208. For example, user profile 202 may indicate that a user has a job title such as “North American Sales Associate.” The information contained in database 210 may indicate that “North American Sales Associate” is a type of salesperson, bridging the terms used in the user profiles 202, skills graph 204, and social interaction graph 208.

With the enterprise social network 200 established, and the skills graph 204 seeded with an initial ontology and vocabulary of skill nouns and verbs, the enterprise social network 200 may begin tracking user interactions. The following is an example of the operations of the various components of the enterprise social network. At 212 a user posts a white paper that uses the terms “Catalyst 6800” and “ham sandwich.” This interaction is monitored and graphed in social interaction graph 208. For example, social interaction graph 208 may graph both the contents of the interaction, mainly the terms “Catalyst 6800” and “ham sandwich” as well as keep track of the frequency with which the user interacts in enterprise social network 200 in ways that include or are related to the terms “Catalyst 6800” and “ham sandwich.”

In step 214, possible skill nouns obtained from the social interaction graph 208 are supplied to the expertise recommendation engine 206. Upon receiving the possible skill nouns “Catalyst 6800” and “ham sandwich,” expertise recommendation engine 206 determines whether the possible skill nouns should be used as skill nouns, and combined with a skill verb. This process may include evaluating information from each of social interaction graph 208, database 210 and skills graph 204. A possible skill noun may be considered a skill noun once it has been the subject of a predetermined number of interactions by the user, or the frequency of interactions related to the subject reaches a predetermined threshold. For example, if social interaction graph 208 indicates that “Catalyst 6800” was used by the user in ten interactions over the last month, and “ham sandwich” was used once, “Catalyst 6800” may be more likely to be determined to be an actual skill noun.

According to other examples, specific interactions may cause possible skill nouns to immediately be considered skill nouns for combining with skill verbs. For example, if a user joins a new team or organization within a company, the subject of the team or organization may immediately be considered a skill noun. If a user changes their role from working in human resources to working in the sales department for a particular product line, and this change is reflected in an interaction in enterprise social network 200, both “sales person” and the product sold by the sales department may be immediately considered skill nouns.

Whether a possible skill noun will be combined with a skill verb may also be determined by contextual information related to the user. For example, expertise recommendation engine 206 may determine from database 210 in step 216 that the user is a “sales engineer.” In step 218 it is determined from skills graph 204 that “Catalyst 6800” is a type of router, it is a commercial product, that sales people sell products, and a sales engineer is a type of sales person. Accordingly, given these connections, in step 220, expertise recommendation engine recognizes “Catalyst 6800” as a skill noun, and combines it with the skill verb “sell” to generate the user skills tag “sells Catalyst 6800.” The term “ham sandwich,” on the other hand, finds no connections in skills graph 204, and therefore, is not determined to be a skill noun, and not combined with a skill verb.

Once the user skill tag “sells Catalyst 6800” has been formed, it may be immediately added to the user's profile 202. According to the example of FIG. 2, user skill tag “sells Catalyst 6800” is first presented to the user for confirmation in step 222. If the user confirms the user skill tag, the user skill tag is added to user profile 202 in step 224. The interactions with the user may be in real-time (e.g., Instant Messages, on-screen pop-up windows, audio or audio/video prompts, etc.) or non-real-time, e.g., email message with a link to a webpage that prompts the user to make the confirmation to a particular user skill tag being considered.

At step 222, the enterprise social network 200 can also take the opportunity to ask/prompt the user to provide additional information. For example, in addition to confirming the user skill tag “sells Catalyst 6800,” the user may be prompted to provide their level of expertise in the skill designated with the user skill tag. Accordingly, the user profile 202 may be updated in step 224 to include the user's level of expertise. The user may indicate that he/she is a “level five expert in selling the Catalyst 6800,” and therefore, this information is added to the user's profile.

At step 222 enterprise social network 200 also provides for crowd-based ontology management by prompting the user to provide additional relationship links between skills The enterprise social network also provides for crowd-based vocabulary updating and management. The skills are received by the enterprise social network in step 226. If the skills provided by the user are already included in the skills graph 204, the additional skills will be added to the user's profile in the form of additional user skill tags in step 228. On the other hand, if the user provides a skill that is not already included in user skill graph 204, the enterprise social network 200 will prompt the user to provide a skill definition and ontological information in step 230 so that the new skill can be added to the vocabulary of skills utilized by enterprise social network 200. The new skill may also be added to skills graph 204 and/or the ontology used to seed skills graph 204, as would be the ontological information. Accordingly, the user may provide additional skill nouns, skill verbs, and full user skill tags that may be used to update the ontology and/or skills graph. In step 232, skills graph 204 is updated with information provided by the user in step 230. Because the updating of the skills graph 204 and ontology can be achieved through crowd-based management, the entries remain up-to-date even for quickly evolving, innovative fields.

As explained above, because the users themselves are providing skills and vocabulary in steps 226, 228 and 230, the skill ontology will remain accurate and current as the ontology is maintained largely by domain experts aware of emerging skills, and not by administrators less versed in the emerging technologies and associated terminologies. Also, due to the users' updating of the skills and vocabulary, enterprise social network 200 generates rich vocabularies for tagging of other objects such as jobs, learning offerings, mentors, project requirements, and will support matching these objects to each other and to people resources. The vocabulary provided in these steps is incorporated into the structure of skills graph 204, allowing the enterprise social network 200 to generate structured data for analytics. For example, if the skills graph is implemented with the Simple Knowledge Organization System (SKOS), the terms generated in steps 226, 228 and 230 will be structured enough to support analytical tasks such as workforce analysis. Furthermore, because the vocabulary is generated directly from the users, administration functions can be reduced.

Once a user profile 202 has user skill tags associated with it, enterprise social network 200 may continue to monitor social interactions associated with the user skill tags, and use this information to weight, and update the user skill tags already associated with the user profile 202. The weighting process may comprise balancing a number of factors to determine the relative weights of the user skill tags. For example, the weighting may take into account the number of interactions a user has made related to a particular user skill tag, the frequency with which a user has interactions related to a particular user skill tag, how recently the user made an interaction related to a particular user skill, and/or how closely a particular user skill tag is related to a user's primary job function

For example, in step 234 additional interactions including “Catalyst 6800” are graphed in social interaction graph 208. In step 236, the additional interactions are passed to expertise weighting engine 240. Based on these new interactions, expertise weighting engine may weight the user skill tags already associated with user profile 202. For example, if the user interacts in enterprise social network 200 regarding “Catalyst 6800” with greater frequency, the “sells catalysts 6800” user skill tag may be weighted higher than other user skill tags associated with user profile 202. On the other hand, if the user interacts in enterprise social network 200 regarding “Catalyst 6800” with decreasing frequency, the “sells catalysts 6800” user skill tag may be weighted lower than other user skill tags associated with user profile 202, or removed from user profile 202 altogether.

The weighting of user skill tags may also take place when a new user skill tag is added to a user profile. Accordingly, expertise weighting engine 240 may be accessed in step 224 in order to weight new user skill tags relative to existing tags as the new user skill tag is being added to user profiles 202.

With accurate user profiles 202 in place, the profiles can be queried and reported on to accurately determine the skills and abilities within an organization's workforce. The user profiles 202 can also be used to accurately find subject matter experts. For example, an organization's helpdesk or call center may be able to quickly and accurately route issues to the best expert for a particular problem by querying the user profiles 202. Furthermore, since the user profiles 202, the skills graph 204 and the ontology can be automatically and dynamically updated, the components of enterprise social network 200 will remain current without overly burdensome administration requirements.

Additionally, because the user profiles 202 include disambiguous user skill tags, the queries performed on the user profiles can more efficiently locate the desired users. For example, if someone is searching for a Catalyst 6800 salesperson, profiles 202 can be queried using a noun/verb combination such as “sells Catalyst 6800.” Since user profiles 202 store disambiguous user skill tags, only users with the skill of selling the Catalyst 6800 router will be returned. On the other hand, in systems with ambiguous tags, searching just on “Catalyst 6800” will return results which include users that have a multitude of skills related to the Catalyst 6800 router, not just sales, but repairing, designing, installing, etc.

Referring now to FIG. 3, depicted therein is example skills graph 300. Skills graph 300 comprises a plurality of user nodes 305a-g. Also included are a plurality of skills nodes 310a-f. Interconnecting user nodes 305a-g and skills nodes 310a-f are verbs 315a-p. Accordingly, the skills graph 300 can be used to determine the appropriate skill verb with which to modify a skill noun for a particular user.

To use a slightly simplified version of the example from FIG. 2 above, a user indicated by node “User A” 305a may have the role of “salesperson.” Accordingly, node “User A” 305a is interconnected with “salesperson” node 310b through verb 315j which has the value “is.” Accordingly, it can be determined that User A is a salesperson. If it is determined that User A has interacted in the enterprise social network such that the skill “router” 310c is determined to be a possible skill noun for User A, skill graph 300 can determine that the verb “sells” is an appropriate skill verb to combine with skill noun “router” due to the interconnection between “salesperson” node 310b and “router” node 310c through verb “sells” 315k.

Skills graph 300 may be implemented and constructed according to SKOS. Other examples may include Conzilla, Cmap Tools Ontology Editor, Rapid Ontology Construction, etc.

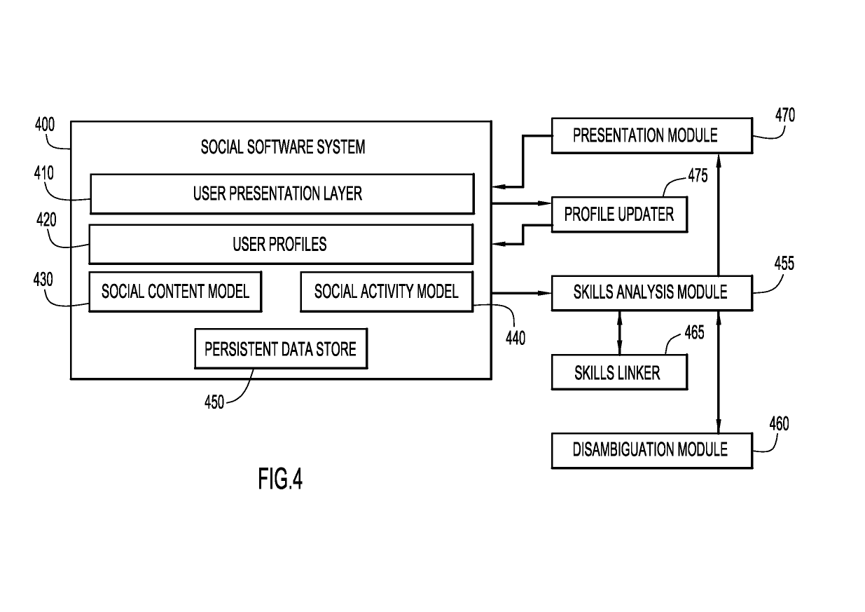

With reference now to FIG. 4, depicted therein is a software system architecture configured to perform the operations of the enterprise social network 200 described above in reference to FIGS. 1-3. According to the example of FIG. 4, all of the components of the enterprise social network, and the skills tagging described above are incorporated in social software system 400. According to other examples, the skills tagging functionality may be embodied in a separate system which operates on top of, or in cooperation with, social software system 400.

Operating within the social software system 400 are several modules including a user presentation layer 410, user profiles 420, social content model 430, social activity model 440, and persistent data store 450. User presentation layer 410 manages the user interactions within the social software system 400. Specifically, the user presentation layer 410 configures the visual appearance of controls, accepts and validates user input; and acquires and displays data received from the other components of the social software system 400. User profiles module 420 contains and manages all the user profile information included in a user profile 202 described above in reference to FIG. 2, including the user skill tags associated with each user. Social content model 430 provides the framework for the types of social content that can be posted, stored, and otherwise accessed through user presentation layer 410 of social software system 400. Social activity model 440 provides the framework for the types of interactions that users can perform with content and other users through user presentation layer 410 of social software system 400. Persistent data store 450 serves as a data repository for all of the data utilized in the social software system 400.

As shown in FIG. 4, there are several other modules operating within social software system 400, including skills analysis module 455, disambiguation module 460, skills linker 465, presentation module 470, and profile updater 475. Skills analysis module 455 monitors the content and activity of a user in order to determine possible skill nouns. For example, the skills analysis module 455 may perform operation 212 of FIG. 2 to monitor and graph user interactions. Disambiguation module 460 applies the concepts of disambiguation using verbs. Specifically, disambiguation module 460 combines skill verbs with skill nouns to form disambiguous user skill tags. The expertise recommendation engine 206 of FIG. 2 may operate within the disambiguation module 460.

Skills linker 465 links concepts based on the ontology, and applies skill weighting. Accordingly, the skills linker 465 may perform operations of step 218 of FIG. 2, to form the actual relationships embodied in the skills graph 206. Additionally, because skills linker 465 also applies skills weighting, the functionality of expertise weighting engine 240, described above in reference to FIG. 2, may be carried out by skills linker 465.

Presentation module 470 operates within presentation layer 410 in order to prompt the user to confirm possible user skill tags and provide additional user skill tags, as described in steps 222 and 224 of FIG. 2, and also to receive user suggestions as described above in step 226. Profile updater 475 updates user profiles in persistent store 450 with the user skills tags which are determined in steps 224 and 228 of FIG. 2.

As indicated above, skills analysis module 455, disambiguation module 460, skills linker 465, presentation module 470, and profile updater 475 can be configured to operate within the social software system 400, but other examples may implement these modules elsewhere. For example skills analysis module 455, disambiguation module 460, skills linker 465, presentation module 470, and profile updater 475 may operate at a user's local personal computer. Additionally, the skills analysis module 455, among others, may be configured to monitor user transactions in any software environment or network. In fact, user interactions or user data stored on an organization's internal network or the entire Internet can be monitored and/or tracked to determine user skill tags according to the techniques described here. For example, if an organization is particularly interested in skills, abilities, interests and expertise of authors, the interactions and postings in online books sellers and/or online libraries may be monitored with the modules described herein.

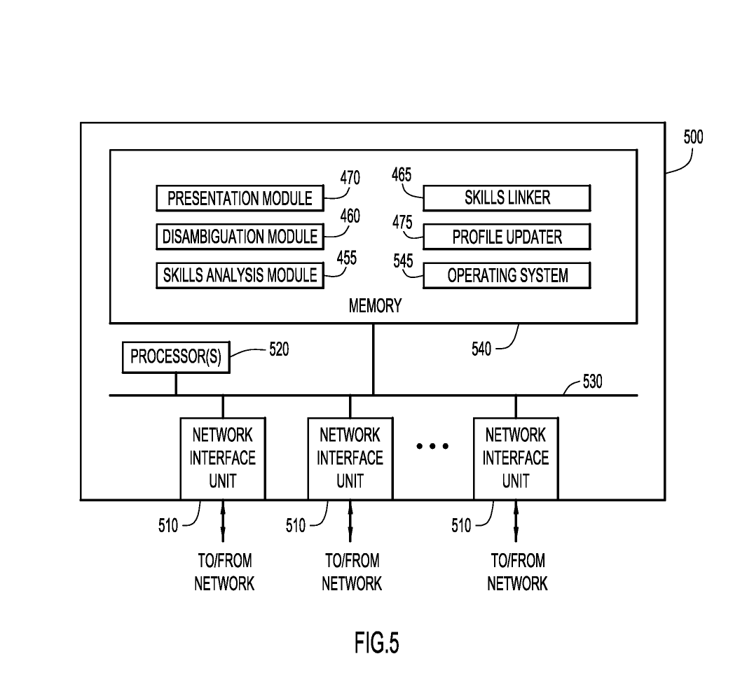

Turning now to FIG. 5, depicted therein is an example block diagram of a device 500 configured to perform the techniques described herein in connection with FIGS. 1-3. The device 500 is a computing apparatus and may take on any of a variety of forms, such as a server computer or virtualized server entity in a cloud computing system. In the example of FIG. 5, the device comprises one or more network interface unit(s) 510, one or more processor(s) 520, a bus 530, and memory 540. The network interface unit 510 may be one or more network interface cards that enables communications over a network with various other entities referred to above. The memory 540 contains software instructions for an operating system 545, skills analysis module 455, disambiguation module 460, skills linker 465, presentation module 470 and profile updater 475 and any one or more of the various other software modules described herein.

Memory 540 may comprise read only memory (ROM), random access memory (RAM), magnetic disk storage media devices, optical storage media devices, flash memory devices, electrical, optical, or other physical/tangible (e.g., non-transitory) memory storage devices. The processor 520 is, for example, a microprocessor or microcontroller that executes instructions for the proxy device logic. Thus, in general, the memory 540 may comprise one or more tangible (non-transitory) computer readable storage media (e.g., a memory device) encoded with software comprising computer executable instructions and when the software is executed (by the processor 520), and in particular skills analysis module 455, disambiguation module 460, skills linker 465, presentation module 470 and profile updater 475, it is operable to perform the operations described herein in connection with FIGS. 1-4.

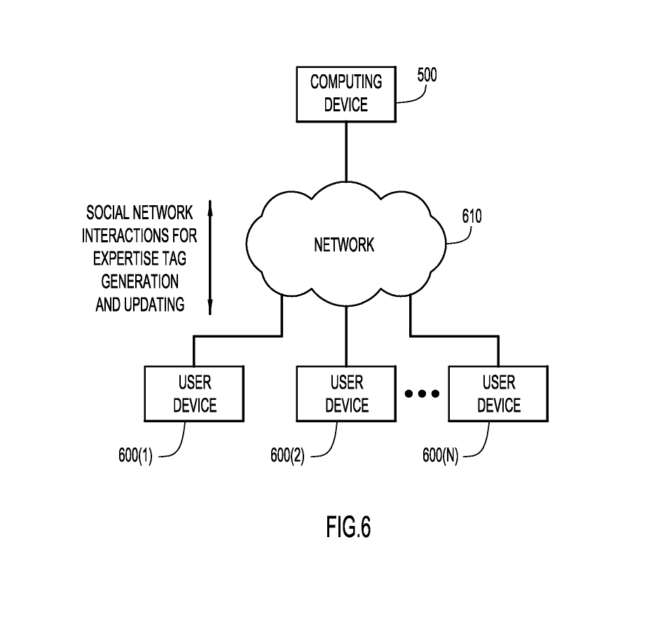

Turning now to FIG. 6, a diagram is shown in which the computing device 500 of FIG. 5 services users via their respective user devices 600(1)-600(N) via a network 610. The network 610 may consist of a collection of networks including, wireless local area networks, wireless wide area networks, wired local area networks, etc. The user devices 600(1)-600(N) may consist of desktop or laptop computers, mobile phones, virtual desktop user work spaces in a cloud computing system, etc. The computing device 500 interactions with users via their user devices to track social network interactions for expertise tag generation and updating according to the techniques described in connection with FIGS. 1-5.

In summary, a method and autonomic system are presented to generate and manage expertise tags based on user participation in a social software network system. The system includes role based disambiguation using verbs (in ontology) and crowd-based ontology management. In particular, the system and method automates interest and expertise tagging. In so doing, skill tags are kept current, facilitating skill tag reduction and removal as necessary. Skill tags are kept complete, avoiding user apathy and generating more relevance of skills and expertise in the system. Furthermore, the skills ontology is accurate and current because it is maintained largely by domain experts aware of emerging skills instead of by administrators.

Structured data is generated that are useful for analytics. For example, terms that are generated by this method of SKOS-based expertise management and tagging will be structured enough to support analytical tasks such as Workforce Analysis. An additional benefit of the this method is that it can create a “data model of expertise” by combining administrator seeded skill definition tags with those generated by the system. This generates rich vocabularies for tagging of other objects such as Jobs, Learning Offerings, Mentors, Project Requirements, and will support matching these objects to each other and to people resources. Finally, this method achieves disambiguation of types of expertise by modifying verbs based on roles.

The above description is intended by way of example only.

What is claimed is:

1. A computer implemented method, comprising:
monitoring interactions of a user in a software environment in which information about the user is collected based on user activities;
obtaining textual information about or derived from an interaction of the user;
determining a skill noun from the textual information obtained for the interaction;
combining the determined skill noun with a skill verb to form a user skill tag; and
updating a profile of the user with the user skill tag.

2. The method of claim 1, wherein combining the skill noun with the skill verb comprises determining the skill verb from a skill ontology.

3. The method of claim 2, wherein combining the determined skill noun with the skill verb from the skill ontology comprises combining the skill noun and the skill verb based on data representing a graph comprising linked-data for related expertise, knowledge, skills and interests.

4. The method of claim 3, wherein determining the skill verb from the skill ontology comprises determining a link corresponding to the skill verb which is common to a first node of the graph for the user and a second node of the graph corresponding for the skill noun.

5. The method of claim 2, further comprising prompting the user to provide at least one of: an additional skill noun, an additional skill verb, or an additional user skill tag.

6. The method of claim 5, further comprising updating the skill graph with the at least one additional skill noun, additional skill verb, or additional user skill tag.

7. The method of claim 6, wherein updating the skill ontology further comprises prompting the user to provide contextual information for the at least one additional skill noun, additional skill verb, or additional user skill tag; and
forming links in the skills ontology from the at least one additional skill noun, additional skill verb, or additional user skill tag according to the contextual information.

8. The method of claim 1, wherein updating the user profile comprises:
presenting the user skill tag to the user; and
prompting the user to confirm the user has the skill identified by the user skill tag.

9. The method of claim 1, wherein updating the user profile with the user skill tag comprises weighting the user skill tag relative to a previously determined user skill tag based on a role of the user in an organization.

10. The method of claim 1, wherein updating the user profile with the user skill tag comprises weighting the user skill tag relative to a previously determined user skill tag based on a frequency of interactions of the user related to the user skill tag and a frequency of interactions of the user related to the previously determined user skill tag.

11. The method of claim 10, further comprising removing the previously determined user skill tag from the user profile when the frequency of interactions of the user related to the previously determined skill drops below a predetermined threshold.

12. The method of claim 1, further comprising prompting the user with a suggested user skill tag determined from links in the skill ontology common to the user skill tag and the suggested user skill tag.

13. The method of claim 1, wherein monitoring interactions of the user comprises monitoring interactions of the user in an enterprise social software platform.

14. The method of claim 1, wherein monitoring further comprises adding a user interaction to a user interaction graph.

15. An apparatus comprising:
a memory configured to store instructions including one or more applications that implement a software environment; and
a processor configured to execute and control the one or more applications so as to:
monitor an interaction of a user in the software environment in which information about the user is collected based on user activities;
obtain textual information about or derived from an interaction of the user;
determine a skill noun from the textual information obtained for the interaction;
combine the determined skill noun with a skill verb to form a user skill tag; and
update a profile of the user with the user skill tag.

16. The apparatus of claim 15, wherein the processor is further configured to determine the skill verb from a skill ontology.

17. The apparatus of claim 16, wherein the processor is further configured to determine the skill verb from a link in a skill graph corresponding to the skill verb which is common to a first node of the skill graph corresponding to the user and a second node of the skill graph corresponding to the skill noun.

18. A tangible computer readable storage medium comprising instructions that when executed by a processor cause the processor to:
monitor an interaction of a user in the software environment in which information about the user is collected based on user activities;
obtain textual information about or derived from an interaction of the user;
determine a skill noun from the textual information obtained for the interaction;
combine the determined skill noun with a skill verb to form a user skill tag; and
update a profile of the user with the user skill tag.

19. The computer readable medium of claim 18, wherein the instructions further cause the processor to determine the skill verb from a skill ontology.

20. The computer readable medium of claim 19, wherein the instructions further cause the processor to determine the skill verb from a link in a skill graph corresponding to the skill verb which is common to a first node of the skill graph corresponding to the user and a second node of the skill graph corresponding to the skill noun.
